(19) United States
(12) Patent Application Publication
(10) Pub. No.: US 2009/0013968 A1
(43) Pub. Date: Jan. 15, 2009

(54) Vapor recovery system for a direct injector fuel rail assembly

(76) Inventors: Kevin R. Keegan, Hilton, NY (US); Jared I. Meeker, Rochester, NY (US); Kirk W. Caloroso, Rochester, NY (US)

Correspondence Address: DELPHI TECHNOLOGIES, INC., M/C 480-410-202, PO BOX 5052, TROY, MI, 48007, US

(21) Appl. No.: 11/825,760

(22) Filed: Jul. 9, 2007

(51) Int. Cl. F02M 61/16

(52) U.S. Cl. 123/470; 123/518

(57) ABSTRACT

A fuel rail assembly for injection of fuel includes a fuel injector socket having a fuel injector assembly inserted, a collar surrounding said fuel injector assembly and providing a gap there between; and a seal sealing the gap between the collar and the fuel injector assembly thereby forming a secondary chamber. Fuel vapors that escape the primary seal of the fuel injector installed in the fuel injector socket are captured in the secondary sealed chamber and are directed to an evaporative control system. The collar is designed such that only minimum modifications are required to both current injectors and current injector sockets. By integrating the collar into a DIG fuel rail assembly in accordance with the invention current DIG internal combustion engines may be converted to PZEV DIG engines.

### TECHNICAL FIELD

The present invention relates to engine management systems and components of internal combustion engines; more particularly, to fuel injection systems for direct injection of fuel; and most particularly, to a collar used in fuel rail assemblies for direct injection of fuel for the collection and control of fuel vapors.

### BACKGROUND OF THE INVENTION

Fuel rails that are used to deliver fuel to individual fuel injectors on internal combustion engines are well known. A fuel rail assembly, also referred to herein simply as a fuel rail, is essentially an elongated tubular fuel manifold connected at an inlet end to a fuel supply system and having a plurality of ports for mating in any of various arrangements with a plurality of fuel injectors to be supplied. Typically, a fuel rail assembly includes a plurality of fuel injector sockets in communication with a manifold supply tube, the injectors being inserted into the sockets. Some fuel rails also incorporate an attached fuel pressure regulator.

Fuel injection arrangements may be divided generally into multi-port fuel injection (MPFI), wherein fuel is injected into a runner of an air intake manifold ahead of a cylinder intake valve, and direct injection gasoline (DIG), wherein fuel is injected directly into the combustion chamber of an engine cylinder, typically during or at the end of the compression stroke of the piston. DIG is designed to allow greater control and precision of the fuel charge to the combustion chamber, resulting in better fuel economy and lower emissions. This is accomplished by enabling combustion of an ultra-lean mixture under many operating conditions. DIG is also designed to allow higher compression ratios, delivering higher performance with lower fuel consumption compared to other fuel injection systems.

A DIG fuel rail must sustain relatively high fuel pressures to assure proper injection of fuel into a cylinder having a compressed charge during the compression stroke. DIG fuel rails may be pressurized to about 100 atmospheres or more, for example.

Typically, a fuel injector is properly oriented to the combustion chamber by being inserted into a fuel injector socket above the combustion chamber such that the socket is sealed and no leakage of liquid fuel may occur. Nevertheless, due to the high pressure in the fuel rail and the injector socket, fuel vapor may still escape past a primary injector seal. Recently created partial zero emissions vehicle (PZEV) emissions requirements make it necessary to capture leaking fuel vapors that until now had been ignored. In order to qualify as a PZEV, a vehicle must have zero evaporative emissions from its fuel system and must have an extended (15 years/150,000-mile) warranty on its emission-control components.

Currently, systems for controlling evaporative emissions include an evaporative emission canister, such as a charcoal canister. Evaporative emission canisters help to limit the amount of fuel vapors released into the environment by reducing evaporative emissions that occur from fuel storage and delivery in a vehicle's fuel system. As fuel vapors and condensed liquid from the fuel tank enter the canister through a tank tube, hydrocarbon molecules in the vapors and liquid are attracted to and stored on the surfaces of the carbon bed inside the canister. This process is called absorption. At controlled intervals, a manifold vacuum draws fresh air through the carbon bed, pulling the gaseous molecules into the intake manifold for combustion. This process is called purging. However, it is currently not possible to contain all escaping fuel vapors with currently used evaporative control systems.

What is needed in the art is a fuel rail assembly for DIG engine fuel systems that helps to reduce evaporative emissions.

What is further needed in the art is a DIG fuel rail assembly that may capture fuel vapors that may otherwise escape past the primary injector seal into the atmosphere.

It is a principal object of the present invention to provide a fuel rail assembly for use with a DIG internal combustion engine that may be an integral part of an effective evaporative control system of a vehicle.

### SUMMARY OF THE INVENTION

Briefly described, a fuel rail assembly for DIG engine fuel systems, in accordance with the invention, includes a collar that creates a secondary sealed chamber around a fuel injector. Fuel vapors that escape the primary seal of the fuel injector installed in a fuel injector socket are captured in the sealed chamber and are directed to an evaporative control system. The collar is designed such that only minimum modifications are required to both current injectors and current injector sockets. In one aspect of the invention, the DIG fuel rail assembly includes a fuel injector socket that has the shape of an extended stepped cup and that accommodates the collar and receives the fuel injector.

In accordance with the present invention, the collar is manufactured from a composite material to eliminate the need for secondary machining, and to keep the weight and the manufacturing costs low. The collar includes at least one groove for receiving an o-ring that assists forming the secondary sealed chamber around the injector. Furthermore, the collar includes an opening for receiving a vapor line. The vapor line connects the secondary sealed chamber with an evaporative emission canister of an evaporative control system. The fuel vapor captured in the secondary sealed chamber created by the collar is returned to the intake manifold for combustion and, therefore, not released to the environment. By integrating the collar into the fuel rail assembly in accordance with the invention current DIG internal combustion engines may be converted to PZEV DIG engines.

### BRIEF DESCRIPTION OF THE DRAWINGS

The present invention will now be described, by way of example, with reference to the accompanying drawings, in which:

FIG. 1 is a cross sectional view of a DIG fuel rail and fuel injector assembly, in accordance with the invention;

FIG. 2 is an isometric view of a collar, in accordance with the invention, of the DIG fuel rail assembly; and

FIG. 3 is a cross-sectional view of the collar taken along line 3-3 in FIG. 2, in accordance with the invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE PREFERRED EMBODIMENTS

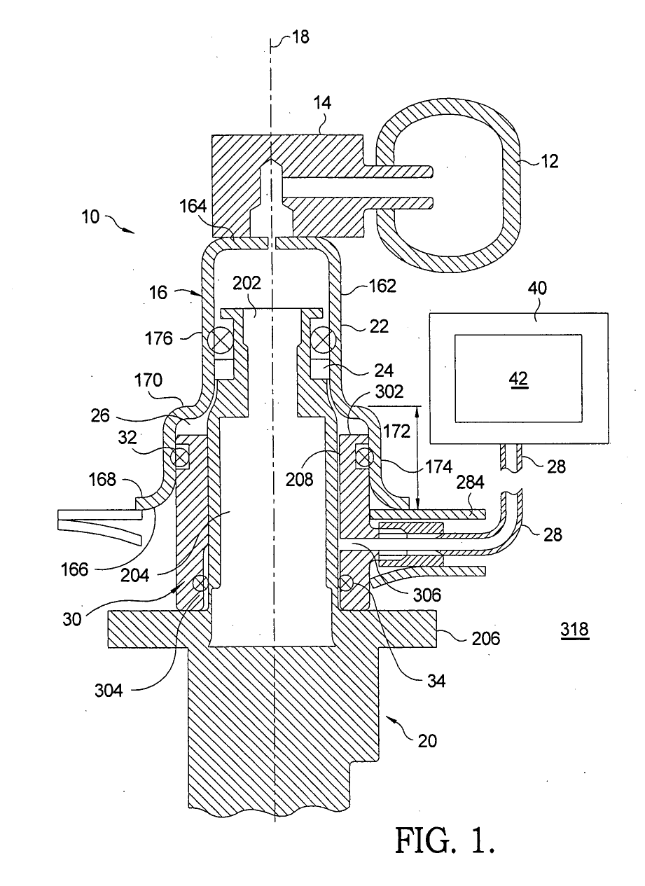

Referring to FIG. 1, a DIG fuel rail assembly 10 with a fuel injector assembly 20 inserted is illustrated in accordance with the invention. The fuel rail assembly 10 includes, as its main components, fuel distribution tube 12, a socket block 14, a fuel injector socket 16, and a collar 30. A passage in socket block 14 connects the fuel injector socket 16 with the fuel distribution tube 12. A plurality of fuel injector sockets 16 may be connected to the distribution tube 12 in one aspect of the invention.

The fuel injector socket 16 includes a generally cylindrical elongated body 162 that extends longitudinally along central axis 18. The body 162 of the injector socket 16 has the shape of an extended stepped cup that is closed at a first end 164 and open at a second end 166. The first end 164 is in fluid communication with fuel distribution tube 12 via the passage in socket block 14. The second end 166 defines a flange 168. Body 162 further includes a step 170 at a distance 172 from the second end 166 and, therefore, flange 168.

A first cylindrical section 174 of body 162 between the flange 168 and the step 170 receives the collar 30. The connection between the body 162 and the collar 30 may be sealed, for example, by an o-ring 32 positioned proximate to a first end 302 of the collar 30. O-ring 32 may not be needed in all applications and may be omitted according to one aspect of the invention.

A second cylindrical section 176 of body 162 between the step 170 and the first end 164 sealably receives an open end 202 of the fuel injector assembly 20 as known in the art. O-ring 22 supported by back-up ring 24 provides the primary seal between the fuel injector assembly 20 and the fuel injector socket 16. While o-ring 22 provides a liquid seal between the fuel injector assembly 20 and the fuel injector socket 16, fuel vapors may still escape past o-ring 22.

In accordance with the invention, first cylindrical section 174 has a larger diameter than second cylindrical section 176 to accommodate collar 30 surrounding a middle section 204 of the fuel injector assembly 20. The fuel injector assembly 20 further includes a shoulder 206 adjacent to the middle section 204. Shoulder 206 supports the collar 30 and holds the collar 30 in position. The collar 30 surrounds middle section 204 of the fuel injector assembly 20 such that a gap 208 exists. An o-ring 34 positioned proximate to a second end 304 of the collar 30 seals the gap 208 from communicating with outside environment 318. A secondary annular chamber 26 is formed by the o-ring 34, the collar 30, the outer circumferential contour of the fuel injector assembly 20, and the inner circumferential contour of the fuel injector socket 16

The collar 30 includes further an opening 306 positioned adjacent to o-ring 34 to provide fluid communication to chamber 26. A vapor line 28 is connected to opening 306 of collar 30 using a seal 284. Opening 306 provides fluid communication between chamber 26 and vapor line 28. Vapor line 28 may be connected at the opposite end from the collar 30 to an evaporative emission canister 42, such as a charcoal canister, of an evaporative control system 40. Evaporative canister 42 and evaporative control system 40 are known in the art.

If fuel vapors escape past the o-ring 22 that provides the primary seal between fuel injector socket 16 and fuel injector assembly 20, the vapors are captured within the sealed annular chamber 26 formed by collar 30 surrounding middle section 204 of the fuel injector assembly 20. The captured fuel vapors vent from the annular chamber 26 to an evaporative emission canister 42 of an evaporative control system 40. At the evaporative emission canister 42, the fuel vapors together with other evaporative emissions that occur from fuel storage and delivery in a fuel system are adsorbed by the carbon bed inside the canister 42. The adsorbed vapors are then purged to the intake manifold for combustion (or sent to the crankcase) and therefore, not released to the environment.

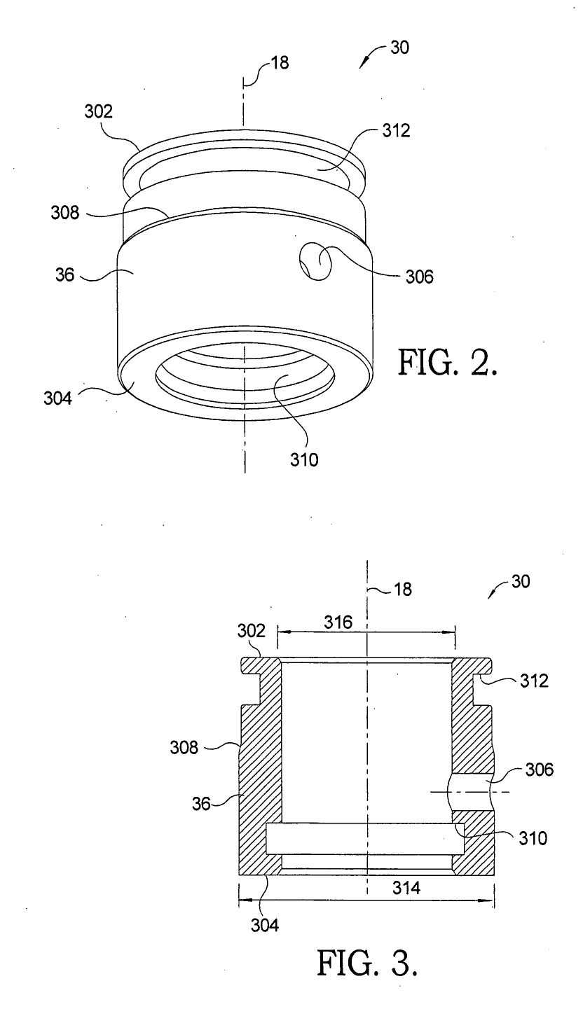

Referring to FIGS. 2 and 3, collar 30 has a generally cylindrical shape and extends longitudinally from a first end 302 to a second end 304 along central axis 18 and includes an opening 306. Collar 30 may be a cylinder 36 of constant thickness around the perimeter or may be a cylinder 36 that includes a step 308 at the outer circumference 314, as shown in FIGS. 2 and 3. Cylinder 36 includes further a groove 310 integrated at the inner circumference 316 and positioned proximate to the second end 304. Groove 310 receives o-ring 34 to seal the secondary chamber 26. Additionally, Cylinder 36 may include an optional groove 312 integrated at the outer circumference and positioned proximate to the first end 302. Groove 312 receives o-ring 32 to provide a seal between the first end 302 of collar 30 and the first cylindrical section 174 of the fuel injector socket 16. Opening 306 may extend from the inner circumference 314 to the outer circumference 316 of Cylinder 36 and is positioned adjacent and above groove 310.

Referring to FIGS. 1, 2 and 3, collar 30 is manufactured as a single piece, for example, from a polymer composite material that is non-permeable by the fuel vapor, during a molding process. Collar 30 may be installed within the DIG fuel rail assembly 10 as shown in FIG. 1. Therefore, the outer circumference 314 of the cylinder 36 is selected to closely fit the inner circumferential contour of the first cylindrical section 174 of the fuel injector socket 16. The inner circumference 316 of the cylinder 36 is selected such that a gap 208 exists between the inner circumference 316 and the outer circumferential contour of the middle section 204 of the fuel injector assembly 20.

As compared to the prior art, DIG fuel rail assembly 10, in accordance with the invention, beneficially provides a secondary sealed chamber 26 surrounding the fuel injector assembly for successfully capturing fuel vapors that typically escape the primary injector seal (o-ring 22). Furthermore, the fluid connection between the secondary sealed chamber 26 and an evaporative control system 40 ensures that the captured fuel vapors are returned for combustion instead of released to the environment.

While collar 30 is shown including groove 310 for receiving o-ring 34 and groove 312 for receiving o-ring 32 it is understood that groove 310 and o-ring 34 may be sufficient for forming sealed chamber 26.

While o-rings 22, 32, and 34 are shown and described for providing a seal between the fuel injector assembly 20 and the fuel injector socket, between the fuel injector socket 16 and the collar 30, and between the collar 30 and the fuel injector assembly 20, respectively, other sealing elements known in the art may be used.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A fuel rail assembly for injection of fuel, comprising:
a fuel injector socket having a fuel injector assembly inserted;
a collar positioned within said fuel injector socket, said collar surrounding said fuel injector assembly and providing a gap there between; and
a seal sealing said gap between said collar and said fuel injector assembly and forming a secondary chamber.

2. The fuel rail assembly of claim 1, wherein said collar includes an opening positioned adjacent to said seal and providing fluid communication with said chamber.

3. The fuel rail assembly of claim 1, further including an additional seal between an inner circumferential contour of said fuel injector socket and an outer circumferential contour of said collar.

4. The fuel rail assembly of claim 1, wherein said fuel injector socket includes a generally cylindrical elongated body that extends longitudinally along a central axis and has the shape of an extended stepped cup.

5. The fuel rail assembly of claim 1, wherein said fuel injector socket includes a closed first end in fluid communication with a fuel rail, an open second end opposite from said first end that defines a flange, and a step at a distance from said second end.

6. The fuel rail assembly of claim 5, wherein said fuel injector socket includes a cylindrical section between said flange and said step that receives said collar.

7. The fuel rail assembly of claim 5, wherein said fuel injector socket includes a cylindrical section between said step and said first end that sealable receives an open end of said fuel injector assembly.

8. The fuel rail assembly of claim 1, wherein said secondary chamber captures fuel vapors that escape past a primary seal between said fuel injector socket and said fuel injector assembly.

9. The fuel rail assembly of claim 1, wherein said secondary chamber is in fluid communication with an evaporative emission canister of an evaporative control system.

10. The fuel rail assembly of claim 1, wherein said fuel injector assembly includes a shoulder at the outer circumference, and wherein said shoulder supports and positions said collar.

11. A collar of a fuel rail assembly for injection of fuel, comprising:
a cylinder extending longitudinally along a central axis from a first end to a second end; and
a first groove integrated at an inner circumference of said cylinder and positioned proximate to said second end.

12. The collar of claim 11, wherein said first groove receives a first o-ring.

13. The collar of claim 11, further including a second groove integrated at the outer circumference of said cylinder and positioned proximate to said first end.

14. The collar of claim 13, wherein said second groove receives a second o-ring.

15. The collar of claim 11, wherein said cylinder includes an opening extending from the inner circumferences to an outer circumference of said cylinder and positioned adjacent and above said first groove.

16. The collar of claim 11, wherein an outer circumference of said cylinder closely fits an inner circumferential contour of a fuel injector socket of a fuel rail assembly for direct injection of fuel.

17. The collar of claim 11, wherein the inner circumference of said cylinder is smaller than an outer circumferential contour of a fuel injector assembly surrounded by said cylinder.

18. A method for capturing fuel vapors that escape past a primary fuel injector seal of an injector of fuel to an internal combustion engine, comprising the steps of:
inserting a collar into a fuel injector socket to surround a fuel injector installed in said fuel injector socket using said primary fuel injector seal; and
creating a secondary sealed chamber with said collar.

19. The method of claim 18, further including the steps of:
capturing said fuel vapors escaping past said primary fuel injector seal within said secondary sealed chamber; and
venting said fuel vapors from said secondary sealed chamber to an evaporative emission canister of an evaporative control system.

20. The method of claim 19, further including the steps of:
adsorbing said fuel vapors with a carbon bed inside said evaporative emission canister; and
returning said fuel vapors to an intake manifold for combustion.
